(19) United States
(12) Patent Application Publication
(10) Pub. No.: US 2026/0080228 A1
(43) Pub. Date: Mar. 19, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Takuya KAWADA, Tokyo (JP); Shota MOTOURA, Tokyo (JP)

(73) Assignee: NEC Corporation, Tokyo (JP)

(21) Appl. No.: 19/401,685

(22) Filed: Nov. 26, 2025

(30) Foreign Application Priority Data
Dec. 12, 2024 (JP) 2024-218089

(51) Int. Cl. G06N 3/0475; G06F 16/3329; G06N 3/045

(52) U.S. Cl. CPC G06N 3/0475; G06F 16/3329; G06N 3/045

(57) ABSTRACT

An information processing apparatus includes a related art acquisition unit that acquires related art information indicating related art related to an analysis target intellectual property based on analysis target information, a positive opinion generation unit that generates a positive opinion regarding a possibility of acquiring a right to the analysis target intellectual property based on the analysis target information and the related art information by using a first model, a negative opinion generation unit that generates a negative opinion regarding the possibility based on the analysis target information and the related art information by using a second model, and a conclusion generation unit that generates a conclusion regarding the possibility based on the positive opinion and the negative opinion by using a third model. This information processing apparatus enhances patentability evaluation through AI-driven decision making support.

### INCORPORATION BY REFERENCE

This application is based upon and claims the benefit of priority from Japanese patent application No. 2024-218089, filed on December 12, 2024, the disclosure of which is incorporated herein in its entirety by reference.

### TECHNICAL FIELD

The present disclosure relates to an information processing apparatus, an information processing method, and an information processing program.

### BACKGROUND ART

JP 2019-179493 A discloses a technique for determining the possibility of acquiring a right for information regarding an intellectual property input by a user. In the technique, a rank indicating the possibility of acquiring the right is presented to the user as a determination result. In a case where the intellectual property is an invention, a degree of coincidence with a similar document is presented to the user for each constituent element of the invention as a determination result.

### SUMMARY

In the technique disclosed in JP 2019-179493 A, there is a case where a user’s satisfaction with the determination result cannot be sufficiently obtained only by the rank of the possibility of acquiring rights, the degree of coincidence with similar documents, and the like as described above. Therefore, it is required to enhance a user’s satisfaction with a determination result.

The present disclosure has been made in view of the above problems, and an exemplary object of the present disclosure is to provide a technique for enhancing a user’s satisfaction with a determination result of a possibility of acquiring a right to an intellectual property.

An information processing apparatus according to an exemplary aspect of the present disclosure includes a related art acquisition unit that acquires related art information indicating related art related to an analysis target intellectual property based on analysis target information in which the analysis target intellectual property is described in a natural language sentence, a positive opinion generation unit that generates a positive opinion regarding a possibility of acquiring a right to the analysis target intellectual property based on the analysis target information and the related art information by using a first large language model, a negative opinion generation unit that generates a negative opinion regarding the possibility of acquiring the right based on the analysis target information and the related art information by using a second large language model, and a conclusion generation unit that generates a conclusion regarding the possibility of acquiring the right based on the positive opinion and the negative opinion by using a third large language model.

An information processing method according to an exemplary aspect of the present disclosure includes a related art acquisition process of, by at least one processor, acquiring related art information indicating related art related to an analysis target intellectual property based on analysis target information in which the analysis target intellectual property is described in a natural language sentence, a positive opinion generation process of, by the at least one processor, generating a positive opinion regarding a possibility of acquiring a right to the analysis target intellectual property based on the analysis target information and the related art information by using a first large language model, a negative opinion generation process of, by the at least one processor, generating a negative opinion regarding the possibility of acquiring the right based on the analysis target information and the related art information by using a second large language model, and a conclusion generation process of, by the at least one processor, generating a conclusion regarding the possibility of acquiring the right based on the positive opinion and the negative opinion by using a third large language model.

An information processing program according to an exemplary aspect of the present disclosure is an information processing program causing at least one processor to function as an information processing apparatus, and to function as a related art acquisition unit that acquires related art information indicating related art related to an analysis target intellectual property based on analysis target information in which the analysis target intellectual property is described in a natural language sentence, a positive opinion generation unit that generates a positive opinion regarding a possibility of acquiring a right to the analysis target intellectual property based on the analysis target information and the related art information by using a first large language model, a negative opinion generation unit that generates a negative opinion regarding the possibility of acquiring the right based on the analysis target information and the related art information by using a second large language model, and a conclusion generation unit that generates a conclusion regarding the possibility of acquiring the right based on the positive opinion and the negative opinion by using a third large language model.

According to an exemplary aspect of the present disclosure, there is an exemplary effect that it is possible to provide a technique for enhancing a user’s satisfaction with a determination result of a possibility of acquiring a right to an intellectual property.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a diagram schematically illustrating an outline of an information processing system according to the present disclosure;

FIG. 4 is a block diagram illustrating a configuration of the information processing system according to the present disclosure;

FIG. 5 is a flowchart illustrating a flow of the information processing method according to the present disclosure;

FIG. 6 is a diagram schematically illustrating an example that is an analysis target input screen according to the present disclosure;

FIG. 7 is a diagram schematically illustrating an example of a generated keyword screen according to the present disclosure;

FIG. 8 is a diagram schematically illustrating an example of a prior art screen according to the present disclosure;

FIG. 9 is a diagram schematically illustrating an example of a difference screen according to the present disclosure;

FIG. 10 is a diagram schematically illustrating an example of a both-opinion screen according to the present disclosure;

FIG. 11 is a diagram schematically illustrating another example of a both-opinion screen according to the present disclosure;

FIG. 12 is a diagram schematically illustrating an example of a conclusion screen according to the present disclosure;

FIG. 13 is a diagram schematically illustrating an example of a final proposal screen according to the present disclosure; and

FIG. 14 is a block diagram illustrating a hardware configuration of a computer that functions as each device according to the present disclosure.

### EXAMPLE EMBODIMENT

Hereinafter, example embodiments will be exemplified. However, the present disclosure is not limited to exemplary example embodiments described below, and various alterations can be made within the scope described in the claims. For example, example embodiments obtained by appropriately combining technologies (some or all of things or methods) adopted in the following exemplary example embodiments can also be included in the scope of the present disclosure. Example embodiments obtained by appropriately omitting some of the technologies adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

### [First Exemplary Example Embodiment]

A first exemplary example embodiment, which is an example of an example embodiment, will be described in detail with reference to the drawings. The present exemplary example embodiment is a basic form of each exemplary example embodiment described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### [Configuration of Information Processing Apparatus 1]

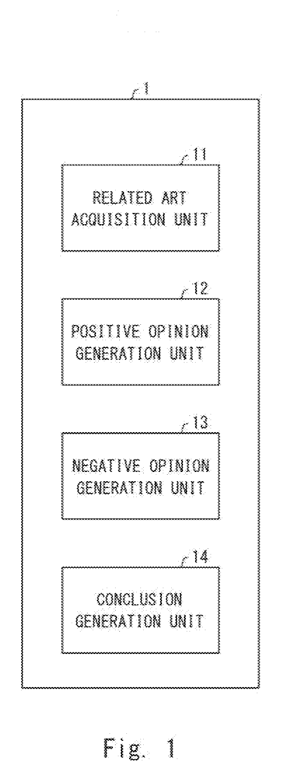

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes a related art acquisition unit 11, a positive opinion generation unit 12, a negative opinion generation unit 13, and a conclusion generation unit 14. The related art acquisition unit 11 is an example of a configuration that achieves related art acquisition means. The positive opinion generation unit 12 is an example of a configuration that achieves positive opinion generation means. The negative opinion generation unit 13 is an example of a configuration that achieves negative opinion generation means. The conclusion generation unit 14 is an example of a configuration that achieves a conclusion generation means.

The related art acquisition unit 11 acquires related art information indicating related art related to an analysis target intellectual property based on analysis target information in which the analysis target intellectual property is described in natural language sentences. Here, the analysis target intellectual property is an intellectual property that can be described in a natural language sentence. For example, the analysis target intellectual property may be an invention, a device, or a paper, but is not limited thereto. The analysis target intellectual property may be an intellectual property in any state such as under consideration, before application, after application, before assessment, or after assessment. For example, the analysis target information may include some or all of information indicating a scope of rights (for example, claims), an outline, and a detailed description. For example, the analysis target intellectual property may be input by a user’s operation, or may be input by being read from any storage medium.

The related art acquisition unit 11 may select related acquisition information based on the analysis target information from among a plurality of candidates for the related art information. The related art acquisition unit 11 may acquire related art information designated by the user according to the analysis target information.

The positive opinion generation unit 12 generates a positive opinion regarding the possibility of acquiring a right to the analysis target intellectual property based on the analysis target information and the related art information by using the first large language model. For example, the possibility of acquiring the right to the analysis target intellectual property may include a possibility that one or both of novelty and inventive step are recognized. For example, the possibility of acquiring the right may include a possibility of satisfying other requirements in addition to novelty and/or inventive step. For example, the positive opinion is a natural language sentence indicating an opinion on the premise that the analysis target intellectual property has novelty and/or inventive step over the related art. For example, a positive opinion may include a natural language sentence indicating novelty and/or inventive step and the grounds therefor.

For example, in a case where the analysis target information and the related art information are input, the first large language model outputs a positive opinion regarding the possibility of acquiring the right. The information input to the first large language model includes at least the analysis target information and the related art information, and may or need not include other information.

For example, the first large language model may be a general-purpose large language model that has been fine-tuned by using positive case information. The positive case information includes, for example, a case of analysis target information, a case of related art information, and a case of a positive opinion regarding a possibility of acquiring a right to an intellectual property indicated by the case that is an analysis target information. Such positive case information may include information obtained regarding other intellectual properties for which the possibility of acquiring the right is actually affirmed, or may include information generated for training.

For example, the first large language model need not necessarily be fine-tuned, and may be a general-purpose large language model. In this case, for example, the positive opinion may be output through in-context learning in which the above positive case information described above is input to the first large language model in addition to the analysis target information and the related art information.

The negative opinion generation unit 13 generates a negative opinion regarding the possibility of acquiring the right to the analysis target intellectual property based on the analysis target information and the related art information by using the second large language model. A specific example of the possibility of acquiring the right to the analysis target intellectual property is as described above. For example, the negative opinion is a natural language sentence indicating an opinion on the premise that the analysis target intellectual property does not have novelty and/or inventive step over the related art. For example, the negative opinion may include a natural language sentence indicating the lack of novelty and/or inventive step and the grounds therefor.

For example, in a case where the analysis target information and the related art information are input, the second large language model outputs a negative opinion regarding the possibility of acquiring the right. The information input to the second large language model includes at least the analysis target information and the related art information, and may or need not include other information.

For example, the second large language model may be a general-purpose large language model that has been fine-tuned by using negative case information. The negative case information includes, for example, a case of analysis target information, a case of related art information, and a case of a negative opinion regarding a possibility of acquiring a right to an intellectual property indicated by the case that is an analysis target information. Such negative case information may include information obtained regarding other intellectual properties for which the possibility of acquiring the right has been actually denied, or may include information generated for training.

For example, the second large language model need not necessarily be fine-tuned, and may be a general-purpose large language model. In that case, the negative opinion may be output through in-context learning in which the above negative case information is input to the second large language model in addition to the analysis target information and the related art information.

The conclusion generation unit 14 generates a conclusion regarding the possibility of acquiring the right to the analysis target intellectual property based on the positive opinion and the negative opinion by using the third large language model. For example, the conclusion is a natural language sentence indicating which of the positive opinion and the negative opinion regarding the presence or absence of novelty and/or inventive step with respect to the related art of the analysis target intellectual property is valid. For example, the conclusion may include either a positive opinion or a negative opinion and a natural language sentence indicating the reasons therefor.

For example, the third large language model outputs a conclusion regarding the possibility of acquiring the right in a case where the analysis target information, the related art information, the positive opinion, and the negative opinion are input. The information input to the third large language model includes at least a positive opinion and a negative opinion, and may or need not include other information.

For example, the third large language model may be a general-purpose large language model that has been fine-tuned by using case information for conclusion. The case information for conclusion may include, for example, business information regarding a business related to the analysis target intellectual property and/or a patent portfolio related to the analysis target intellectual property. As a result, it is possible to generate a conclusion in view of the business information and/or the patent portfolio. The case information for conclusion includes, for example, a case of analysis target information, a case of related art information, a case of a positive opinion, a case of a negative opinion, and a case of a conclusion. Such case information for conclusion may be generated to include a positive opinion and a negative opinion generated by the positive opinion generation unit 12 and the negative opinion generation unit 13 with respect to other intellectual properties for which the possibility of acquiring the right has been actually affirmed or denied. Such conclusion case information may also be information generated for training.

For example, the third large language model need not necessarily be fine-tuned, and may be a general-purpose large language model. In that case, the conclusion may be output through in-context learning in which the above case information for conclusion is input to the third large language model in addition to the analysis target information, the related art information, the positive opinion, and the negative opinion.

In a case where at least two of the first large language model, the second large language model, and the third large language model are fine-tuned models, the at least two models are different from each other. For example, in a case where at least two of the first large language model, the second large language model, and the third large language model are general-purpose large language models, the at least two models may be the same or different.

### [Effect of Information Processing Apparatus 1]

As described above, the information processing apparatus 1 adopts a configuration including the related art acquisition unit 11 that acquires, based on analysis target information in which an analysis target intellectual property is described in a natural language sentence, related art information indicating related art related to the analysis target intellectual property, the positive opinion generation unit 12 that generates, by using the first large language model, a positive opinion regarding a possibility of acquiring a right to the analysis target intellectual property, based on the analysis target information and the related art information, the negative opinion generation unit 13 that generates, by using the second large language model, a negative opinion regarding the possibility of acquiring the right based on the analysis target information and the related art information, and the conclusion generation unit 14 that generates, by using the third large language model, a conclusion regarding the possibility of acquiring the right based on the positive opinion and the negative opinion. Therefore, according to the information processing apparatus 1, since the conclusion is generated based on both the positive opinion and the negative opinion regarding the possibility of acquiring the right to the intellectual property, it is possible to obtain an effect that the user’s satisfaction with the conclusion regarding the possibility of acquiring the right can be enhanced.

### [Flow of Information Processing Method S1]

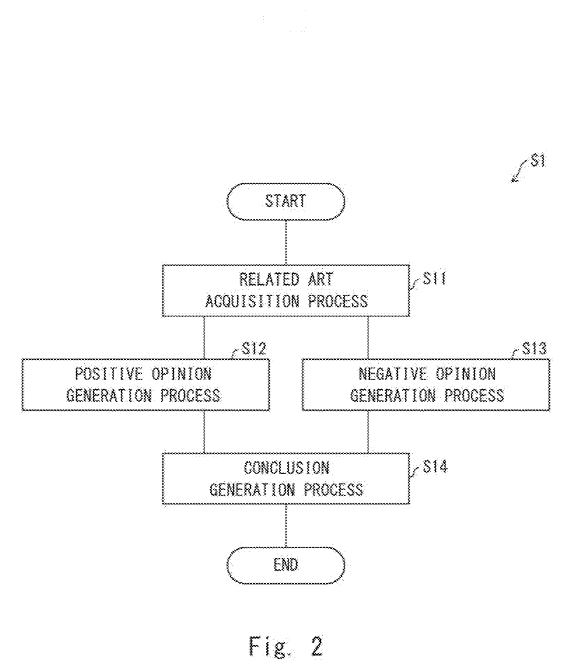

A flow of an information processing method S1 will be described with reference to FIG. 2. For example, in a case where the information processing apparatus 1 includes at least one processor, the information processing apparatus 1 executes the information processing method S1. FIG. 2 is a flowchart illustrating the flow of the information processing method S1. As illustrated in FIG. 2, the information processing method S1 includes a related art acquisition process S11, a positive opinion generation process S12, a negative opinion generation process S13, and a conclusion generation process S14.

In the related art acquisition process S11, at least one processor (for example, the related art acquisition unit 11) acquires, based on analysis target information in which an analysis target intellectual property is described in a natural language sentence, related art information indicating related art related to the analysis target intellectual property. Details of the related art acquisition process S11 will be described in the same manner as the details of the related art acquisition unit 11 described above.

In the positive opinion generation process S12, at least one processor (for example, the positive opinion generation unit 12) generates a positive opinion regarding the possibility of acquiring the right to the analysis target intellectual property based on the analysis target information and the related art information by using the first large language model. Details of the positive opinion generation process S12 will be described in the same manner as the details of the positive opinion generation unit 12 described above.

In the negative opinion generation process S13, at least one processor (for example, the negative opinion generation unit 13) generates a negative opinion regarding the possibility of acquiring the right to the analysis target intellectual property based on the analysis target information and the related art information by using the second large language model. Details of the negative opinion generation process S13 will be described in the same manner as the details of the negative opinion generation unit 13 described above.

The positive opinion generation process S12 and the negative opinion generation process S13 are not limited to being executed in the order described above, and may be executed in the reverse order, or some or all of the processes may be executed in parallel.

In the conclusion generation process S14, at least one processor generates a conclusion regarding the possibility of acquiring the right to the analysis target intellectual property based on the positive opinion and the negative opinion by using the third large language model. Details of the conclusion generation processing S14 will be described in the same manner to the details of the conclusion generation unit 14 described above.

### [Effect of Information Processing Method S1]

As described above, the information processing method S1 adopts a configuration including the related art acquisition process S11 in which at least one processor acquires the related art information indicating the related art related to the analysis target intellectual property based on the analysis target information in which the analysis target intellectual property is described in the natural language sentence, the positive opinion generation process S12 in which the at least one processor generates a positive opinion regarding the possibility of acquiring the right to the analysis target intellectual property based on the analysis target information and the related art information by using the first large language model, the negative opinion generation process S13 in which the at least one processor generates a negative opinion regarding the possibility of acquiring the right based on the analysis target information and the related art information by using the second large language model, and the conclusion generation process S14 in which the at least one processor generates a conclusion regarding the possibility of acquiring the right based on the positive opinion and the negative opinion by using the third large language model. Therefore, according to the information processing method S1, the same effects as those of the information processing apparatus 1 can be obtained.

### [Second Exemplary Example Embodiment]

A second exemplary example embodiment, which is an example of an example embodiment, will be described in detail with reference to the drawings. Constituents having the same functions as the constituents described in the above-described exemplary example embodiment are denoted by the same reference sign, and the description thereof will be omitted as appropriate. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### [Outline of Information Processing System 100A]

An information processing system 100A presents, based on an analysis target claim (an example of analysis target information) and a prior art document (an example of related art information), a positive opinion, a negative opinion, and a conclusion regarding novelty and inventive step (an example of a possibility of acquiring a right) of a target invention (an example of an intellectual property) indicated by the analysis target claim. The information processing apparatus 1A generates an improvement proposal (an example of improvement proposal information) of a claim in a case where the conclusion does not satisfy a predetermined condition, repeats an operation with the improvement proposal as a new analysis target claim, and thus presents an improvement proposal in which the conclusion satisfies the predetermined condition to a user as a final proposal.

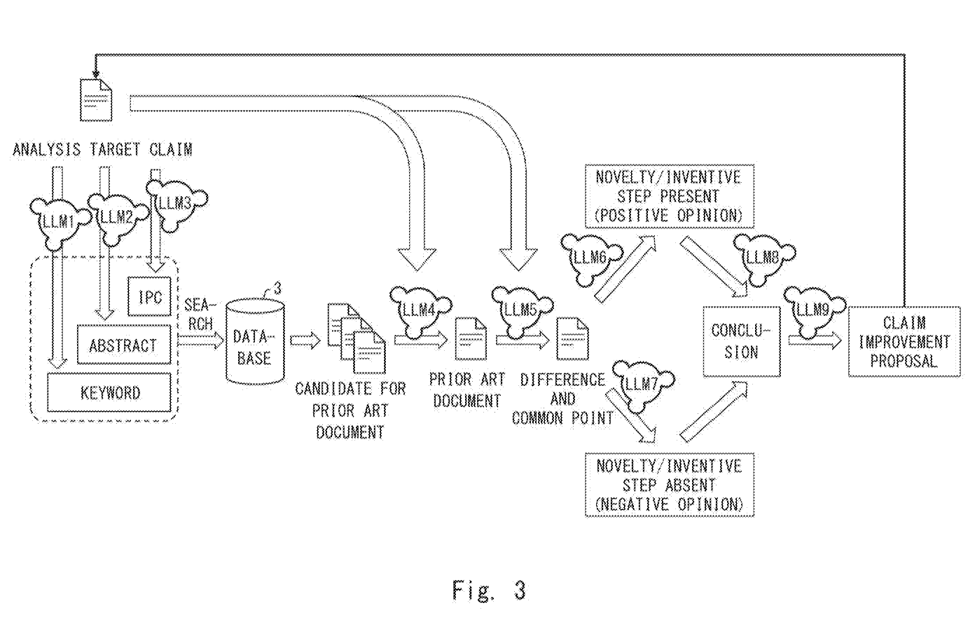

FIG. 3 is a diagram schematically illustrating an outline of the information processing system 100A. As illustrated in FIG. 3, in the information processing system 100A, a keyword is generated from an analysis target claim by using a large language model LLM1, or an abstract is generated by using the large language model LLM2. There may be an aspect in which the keyword and the abstract are generated, but the description will be continued focusing on an aspect in which either one is generated. A classification such as IPC (International Patent Classification) is specified from an analysis target claim by using a large language model LLM3. Next, a plurality of candidates for prior art documents are acquired from a database 3 that will be described later by using the keyword or the abstract and the classification. Next, a prior art document to be compared with the analysis target claim is specified from a plurality of candidates for prior art documents by using a large language model LLM4. Next, a difference and a common point between the analysis target claim and the prior art document are analyzed by using a large language model LLM5. Next, a positive opinion regarding novelty and inventive step of a target invention indicated by the analysis target claim is generated by using a large language model LLM6. A negative opinion regarding novelty and inventive step of the target invention is generated by using the large language model LLM7. Next, a conclusion as to which of the positive opinion and negative opinion is valid is generated by using a large language model LLM8. Next, in a case where the conclusion does not satisfy a predetermined condition (for example, the conclusion is not a positive opinion), an improvement proposal of the claim is generated by using a large language model LLM9. The above-described series of processes is performed again with the claim improvement proposal as a new analysis target claim.

### [Configuration of Information Processing System 100A]

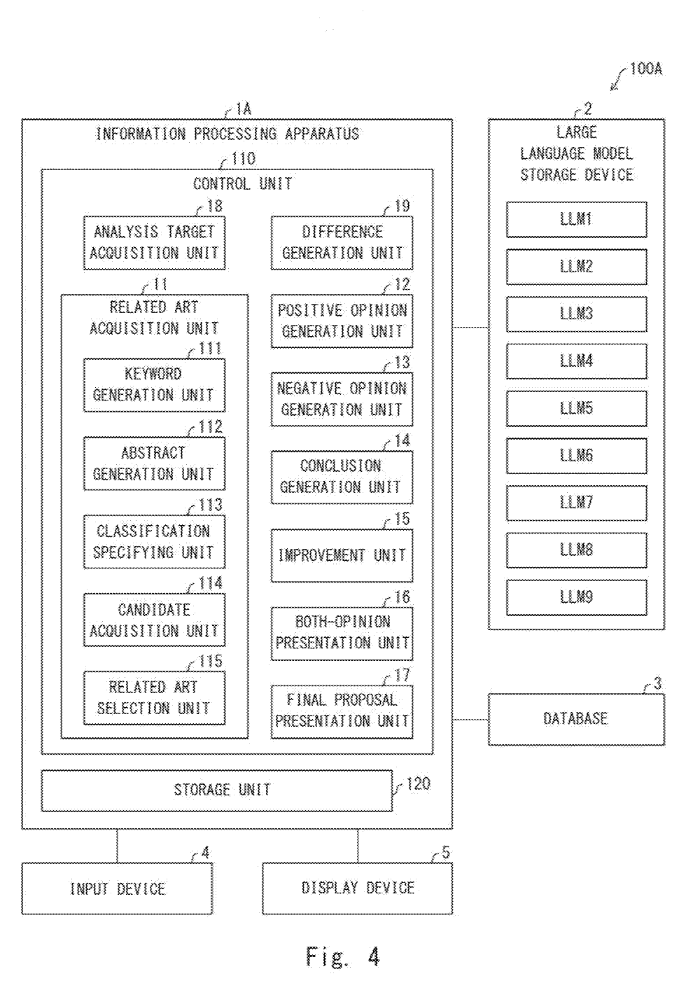

A configuration of the information processing system 100A will be described with reference to FIG. 4. FIG. 4 is a block diagram illustrating the configuration of the information processing system 100A. As illustrated in FIG. 4, the information processing system 100A includes an information processing apparatus 1A, a large language model storage device 2, a database 3, an input device 4, and a display device 5. The information processing apparatus 1A is communicatively connected to the large language model storage device 2, the database 3, the input device 4, and the display device 5 via a network, a peripheral device connection interface, or the like. A part or the whole of the information stored in the large language model storage device 2 and the database 3 may be stored in a storage unit 120 of the information processing apparatus 1A. One or both of the input device 4 and the display device 5 may be built into the information processing apparatus 1A instead of being connected to the information processing apparatus 1A. The input device 4 and the display device 5 may be connected to or built into a user terminal (not illustrated), and the user terminal may be communicatively connected to the information processing apparatus 1A via a network. Although FIG. 4 illustrates one large language model storage device 2, one database 3, one input device 4, and one display device 5, the information processing system 100A may include each of some or all of these devices in a plurality.

### [Large Language Model Storage Device 2]

The large language model storage device 2 stores the large language models LLM1 to LLM9. Each of the large language models LLM1 to LLM9 is a deep learning model generated to execute a natural language processing task. For example, the large language models LLM1 to LLM9 are models that execute a sentence generation task, and are models that output a natural language sentence generated with a prompt based on a natural language sentence as an input. Each of the large language models LLM1 to LLM9 may be a model obtained by fine-tuning a general-purpose large language model or may be a general-purpose large language model. In a case where at least one of the large language models LLM1 to LLM9 is a general-purpose large language model, in-context learning may be performed by using the large language model. In a case where at least two of the large language models LLM1 to LLM9 are general-purpose large language models, the two models may be the same model or different models.

The large language model LLM1 is an example of a fifth large language model used to generate a keyword. For example, in a case where an analysis target claim is input, the large language model LLM1 outputs a keyword related to the analysis target claim. For example, the large language model LLM1 may be a general-purpose large language model fine-tuned for a technical field assumed in the analysis target claim. The large language model LLM1 may be a general-purpose large language model. In that case, the keyword may be output by inputting knowledge related to the field indicated by the analysis target claim to the large language model LLM1 in addition to the analysis target claim.

The large language model LLM2 is an example of a large language model used to generate an abstract of analysis target information. For example, in a case where an analysis target claim is input, the large language model LLM2 outputs an abstract thereof. For example, the large language model LLM2 may be fine-tuned for a technical field assumed in the analysis target claim. The large language model LLM2 may be a general-purpose large language model. In that case, the abstract may be output by inputting knowledge related to the field indicated by the analysis target claim to the large language model LLM2 in addition to the analysis target claim.

The large language model LLM3 is an example of a seventh large language model used to specify a classification of an intellectual property indicated by the analysis target information. For example, in a case where an analysis target is an invention, the above-described IPC can be cited as an example of the “classification of the intellectual property”, but the present disclosure is not limited thereto. For example, the large language model LLM3 outputs a classification in a case where an analysis target claim is input. For example, the large language model LLM3 may be obtained by fine-tuning a general-purpose large language model by using case information for specifying a classification. The case information for specifying a classification includes a case of an analysis target claim and a case of a classification. The case information for specifying a classification may be generated based on, for example, published patent documents. The large language model LLM3 may be a general-purpose large language model. In that case, the classification may be output through in-context learning in which the case information for specifying a classification is input to the large language model LLM3 in addition to the analysis target claim.

The large language model LLM4 is an example of a sixth large language model used to select related art information from a plurality of candidates. For example, in a case where an analysis target claim and a plurality of patent documents are input, the large language model LLM4 outputs a patent document relevant to the analysis target claim among the plurality of patent documents as a prior art document. For example, the large language model LLM4 may be a general-purpose large language model fine-tuned for a technical field assumed in the analysis target claim. The large language model LLM4 may be a general-purpose large language model. In that case, the most related prior art documents may be output by inputting knowledge related to the field indicated by the analysis target claim to the large language model LLM4 in addition to the analysis target claim and the plurality of patent documents.

The large language model LLM5 is used to generate a difference and a common point between analysis target information and related art information. For example, in a case where an analysis target claim and a prior art document are input, the large language model LLM5 outputs a difference and a common point between the analysis target claim and the prior art document. For example, the large language model LLM5 may be obtained by fine-tuning a general-purpose large language model by using case information including a difference and a common point. The case information including the difference and the common point includes a case of the analysis target claim, a case of the prior art document, and a case of a difference and a case of the common point between the two cases. The case information including the difference and the common point may be generated based on, for example, progress information of published patent documents, or may include information generated for training. The large language model LLM5 may be a general-purpose large language model. In that case, the difference and the common point may be output through in-context learning in which case information including the above-described difference and common point is input to the large language model LLM5 in addition to the analysis target claim and the prior art document.

The large language model LLM6 is an example of a first large language model used to generate a positive opinion. For example, in a case where a difference and a common point between the analysis target claim and the prior art document are input, the large language model LLM6 outputs a positive opinion regarding novelty and inventive step of a target invention indicated by the analysis target claim. The positive opinion includes an opinion that the target invention has novelty and inventive step and grounds therefor. For example, the large language model LLM6 may be a general-purpose large language model fine-tuned using positive case information. Positive case information includes cases of differences and common points between the case of the analysis target claim and the case of the prior art documents, and cases of positive opinions regarding novelty and inventive step of the case of the target invention indicated by the case of the analysis target claim. The positive case information may be generated based on, for example, progress information of published patent documents, or may include information generated for training. The large language model LLM6 may be a general-purpose large language model. In that case, the positive opinion may be output through in-context learning in which the positive case information described above is input to the large language model LLM6 in addition to the difference and the common point between the analysis target claim and the prior art document.

The large language model LLM7 is an example of a second large language model used to generate a negative opinion. For example, in a case where a difference and a common point between the analysis target claim and the prior art document are input, the large language model LLM7 outputs a negative opinion regarding novelty and inventive step of a target invention indicated by the analysis target claim. The negative opinion may include an opinion that the target invention lacks novelty and inventive step and the grounds therefor. The negative opinion may include an opinion that the target invention has novelty but does not have inventive step and the grounds therefor. For example, the large language model LLM7 may be obtained by fine-tuning a general-purpose large language model by using negative case information. The negative case information includes a case of a difference and a case of a common point between the case of the analysis target claim and the case of the prior art document, and a case of a negative opinion regarding novelty and inventive step of the case of the analysis target claim. The negative case information may be generated based on, for example, progress information of published patent documents, or may include information generated for training. The large language model LLM7 may be a general-purpose large language model. In that case, the negative opinion may be output through in-context learning in which the above-described negative case information is input to the large language model LLM7 in addition to the difference and common point between the analysis target claim and the prior art document.

The large language model LLM8 is an example of a third large language model used to generate a conclusion. For example, the large language model LLM8 outputs a conclusion in a case where an analysis target claim, a prior art document, a positive opinion, and a negative opinion are input. The conclusion includes a conclusion as to whether a positive opinion or a negative opinion is valid and the grounds therefor. For example, the large language model LLM8 may be a general-purpose large language model fine-tuned by using case information for conclusion. As described above, the case information for conclusion may include, for example, business information regarding a business related to the analysis target intellectual property and/or a patent portfolio related to the analysis target intellectual property. As a result, it is possible to generate a conclusion in view of the business information and/or the patent portfolio. The case information for conclusion includes a case of an analysis target claim, a case of a prior art document, a case of a positive opinion, a case of a negative opinion, and a case of a conclusion. The case information for conclusion may be generated based on, for example, progress information of published patent documents, or may include information generated for training. For example, the case of a positive opinion and the case of a negative opinion in the case information for conclusion may be generated by using the large language models LLM6 and LLM7 with the case of the analysis target claim and the case of the prior art document as inputs. The large language model LLM8 may be a general-purpose large language model. In that case, the conclusion may be output through in-context learning in which the above case information for conclusion is input to the large language model LLM8 in addition to the analysis target claim, the prior art document, the positive opinion, and the negative opinion.

The large language model LLM9 is an example of a fourth large language model used to generate improvement proposal information. For example, in a case where an analysis target claim, a prior art document, a difference and a common point, a positive opinion, a negative opinion, and a conclusion are input, the large language model LLM9 outputs an improvement proposal of the analysis target claim. For example, the large language model LLM9 may be obtained by fine-tuning a general-purpose large language model by using case information for improvement. The case information for improvement may include, for example, business information regarding a business related to an analysis target intellectual property, a patent portfolio related to the analysis target intellectual property, and/or strategy information regarding the patent portfolio. As a result, an important configuration in the business information, the patent portfolio, and/or the strategy information can be included in the improvement proposal information. The case information for improvement includes a case of an analysis target claim, a case of a prior art document, cases of a difference and a common point, a case of a positive opinion, a case of a negative opinion, a case of a conclusion, and a case of an improvement proposal. The case information for improvement may be generated based on, for example, progress information of published patent documents. For example, the case of the improvement proposal may be generated based on an amendment of the claims in the progress information. The case information for improvement may include information generated for training. The large language model LLM9 may be a general-purpose large language model. In that case, the improvement proposal may be output through in-context learning in which the case information for improvement is input to the large language model LLM9 in addition to the analysis target claim, the prior art document, the difference and the common point, the positive opinion, the negative opinion, and the conclusion.

### [Database 3]

The database 3 stores a search target of related art information. For example, the database 3 may store a plurality of patent documents as search targets. For example, the database 3 may store each of a plurality of patent documents in an aspect in which search based on similarity of features can be performed. For example, each patent document may be associated with a vector expression indicating a feature of the patent document. The vector expression may be information obtained by converting at least a part (for example, claims and an abstract) of each patent document into a vector format by using an embedding model. In this case, each patent document is indexed in the vector format. Each process of conversion into the vector format and indexing may be executed in advance by the related art acquisition unit 11 or may be executed in advance by an apparatus outside the information processing apparatus 1A. The search target of the related art information stored in the database 3 is not limited to patent documents, and may include non-patent documents.

### [Input Device 4 and Display Device 5]

The input device 4 is configured to receive an input to the information processing apparatus 1A, and may include an input device such as a keyboard, a mouse, a touch panel, a camera, or a microphone, as an example. The display device 5 is configured to display a screen output from the information processing apparatus 1A, and may include a display as an example. The input device 4 and the display device 5 may be integrally formed as a touch panel or the like.

### [Configuration of Information Processing Apparatus 1A]

As illustrated in FIG. 4, the information processing apparatus 1A includes a control unit 110 and a storage unit 120. The control unit 110 integrally controls each unit of the information processing apparatus 1A. The storage unit 120 stores various types of data and programs referred to by the control unit 110.

The control unit 110 includes, in addition to the related art acquisition unit 11, the positive opinion generation unit 12, the negative opinion generation unit 13, and the conclusion generation unit 14 included in the information processing apparatus 1, an improvement unit 15, a both-opinion presentation unit 16, a final proposal presentation unit 17, an analysis target acquisition unit 18, and a difference generation unit 19. The improvement unit 15 is an example of a configuration that achieves improvement means. The both-opinion presentation unit 16 is an example of a configuration that achieves both-opinion presentation means. The final proposal presentation unit 17 is an example of a configuration that achieves final proposal presentation means.

The analysis target acquisition unit 18 acquires an analysis target claim (an example of analysis target information). The analysis target claim may be acquired, for example, based on a user’s operation using the input device 4.

The related art acquisition unit 11 is configured as follows in addition to being configured similarly to the first exemplary example embodiment. The related art acquisition unit 11 may generate a keyword or an abstract from an analysis target claim (an example of analysis target information) by using the large language model LLM1 or LLM2, and acquire a prior art document (an example of related art information) from the database 3 by using the generated keyword or abstract. The related art acquisition unit 11 may acquire a plurality of candidates for prior art documents (an example of related art information) and select any of the plurality of candidates as a prior art document (an example of related art information) by using the large language model LLM4. The related art acquisition unit 11 may specify a classification of an invention that is an analysis target (an example of an analysis target intellectual property) by using the large language model LLM3, and acquire a prior art document (an example of related art information) by using the specified classification.

For example, the related art acquisition unit 11 includes a keyword generation unit 111, an abstract generation unit 112, a classification specifying unit 113, a candidate acquisition unit 114, and a related art selection unit 115.

The keyword generation unit 111 generates a keyword from the analysis target claim by using the large language model LLM1. Details of the large language model LLM1 are as described above. As a result, it is possible to acquire a plurality of candidates for prior art documents from the database 3 based on the similarity with the keyword. The keyword generation unit 111 may acquire the keyword input by a user instead of or in addition to generating the keyword from the analysis target claim by using the large language model LLM1.

The abstract generation unit 112 generates an abstract from the analysis target claim by using the large language model LLM2. Details of the large language model LLM2 are as described above. As a result, a plurality of candidates for prior art documents can be acquired from the database 3 based on the similarity with the abstract.

In order to acquire a plurality of candidates for prior art documents, which one of the keyword and the abstract will be used may be selectable by the user. In a case where which one of the keyword and the abstract will be used is not selected by the user, either one (for example, the keyword) that is defined in advance may be used, and the other (for example, the abstract) may be optionally selected based on an operation of the user. Which one of the keyword and the abstract is used may be selected based on a predetermined condition without depending on the user’s operation. For example, in a case where an input analysis target claim has a length equal to or more than a threshold, an abstract may be generated, and otherwise, a keyword may be generated.

The classification specifying unit 113 specifies a classification of the analysis target claim by using the large language model LLM3. Details of the large language model LLM3 are as described above. As a result, it is possible to narrow down a plurality of candidates for prior art documents based on the classification.

The candidate acquisition unit 114 acquires a plurality of candidates for prior art documents from the database 3 by using the generated keyword or abstract and the specified classification. For example, the candidate acquisition unit 114 generates a vector expression indicating a feature of the generated keyword or abstract by using the embedding model. The candidate acquisition unit 114 specifies a plurality of patent documents in which the similarity between the vector representation of the keyword or the abstract and a vector representation of a patent document is equal to or more than a threshold among the patent documents stored in the database 3. The candidate acquisition unit 114 acquires, as a plurality of candidates for prior art documents, documents matching the specified classification among the plurality of patent documents. As a result, it is possible to acquire more appropriate patent documents as a plurality of candidates for prior art documents from the database 3 compared with the case of simply using a keyword or an abstract. In a case where the candidate acquisition unit 114 has acquired only one candidate (for example, one patent document having a similarity to a keyword or an abstract equal to or more than a threshold, or one patent document matching the specified classification), a process performed by the related art selection unit 115 described below can be omitted.

The related art selection unit 115 selects any of the plurality of candidates for prior art documents as a prior art document by using the large language model LLM4. One or more prior art documents may be selected. Details of the large language model LLM4 are as described above. As a result, it is possible to specify an appropriate prior art document as a comparison target with the analysis target claim from among a plurality of candidates for prior art documents acquired based on the similarity with the keyword or the abstract and the classification. The related art selection unit 115 may select a candidate selected by the user among the plurality of candidates as a prior art document. The related art selection unit 115 may select a prior art document from among a plurality of candidates by using the large language model LLM4 in a case where the user instructs that a computer selects the prior art document.

The difference generation unit 19 generates a difference and a common point between the analysis target claim and the prior art document by using the large language model LLM5. Details of the large language model LLM5 are as described above.

The positive opinion generation unit 12 is configured as follows in addition to being configured similarly to the first exemplary example embodiment. The positive opinion generation unit 12 generates a positive opinion regarding novelty and inventive step of an invention that is the analysis target based on the difference and the common point between the analysis target claim and the prior art document by using the large language model LLM6. Details of the large language model LLM6 are as described above.

The negative opinion generation unit 13 is configured as follows in addition to being configured similarly to the first exemplary example embodiment. The negative opinion generation unit 13 generates a negative opinion regarding novelty and inventive step of an invention that is a branch target based on the difference and the common point between the analysis target claim and the prior art document by using the large language model LLM7. Details of the large language model LLM7 are as described above.

The conclusion generation unit 14 is configured as follows in addition to being configured similarly to the first exemplary example embodiment. The conclusion generation unit 14 generates a conclusion regarding novelty and inventive step of the target invention based on the analysis target claim, the prior art documents, the positive opinion, and the negative opinion by using the large language model LLM8.

The improvement unit 15 generates a claim improvement proposal (an example of improvement proposal information) indicating an improvement proposal of an analysis target claim (an example of analysis target information) by using the large language model LLM9. Details of the large language model LLM9 are as described above. The related art acquisition unit 11, the positive opinion generation unit 12, the negative opinion generation unit 13, and the conclusion generation unit 14 function again with the claim improvement proposal as a new analysis target claim. For example, the improvement unit 15 may generate a claim improvement proposal in a case where the conclusion does not satisfy a predetermined condition that will be described later. For example, the improvement unit 15 may generate a claim improvement proposal in a case where the user gives an instruction for improvement of a claim regardless of whether the conclusion satisfies the predetermined condition. As a result, since the generation of a claim improvement proposal is recursively repeated, the claim improvement proposal can be created while gradually increasing the possibility that novelty and inventive step are affirmed.

The both-opinion presentation unit 16 presents a positive opinion and a negative opinion to the user. As a result, the user’s satisfaction with the conclusion is improved compared with a case where the conclusion is simply presented.

In a case where a conclusion generated by using a claim improvement proposal (an example of improvement proposal information) as an analysis target claim satisfies a predetermined condition, the final proposal presentation unit 17 presents the claim improvement proposal to the user as a claim final proposal (an example of final proposal information). The predetermined condition may be, for example, that a positive opinion regarding novelty and inventive step is valid. The predetermined condition may be, for example, that a positive opinion regarding at least novelty is valid. In this case, in other words, the predetermined condition may be satisfied, for example, in a case where a negative opinion that a target invention has novelty but does not have inventive step is valid. However, the predetermined condition is not limited thereto. As a result, it is possible to present a claim final proposal with a higher possibility that novelty and inventive step are affirmed to the user, and the user’s satisfaction is improved.

### Flow of Information Processing Method S1A

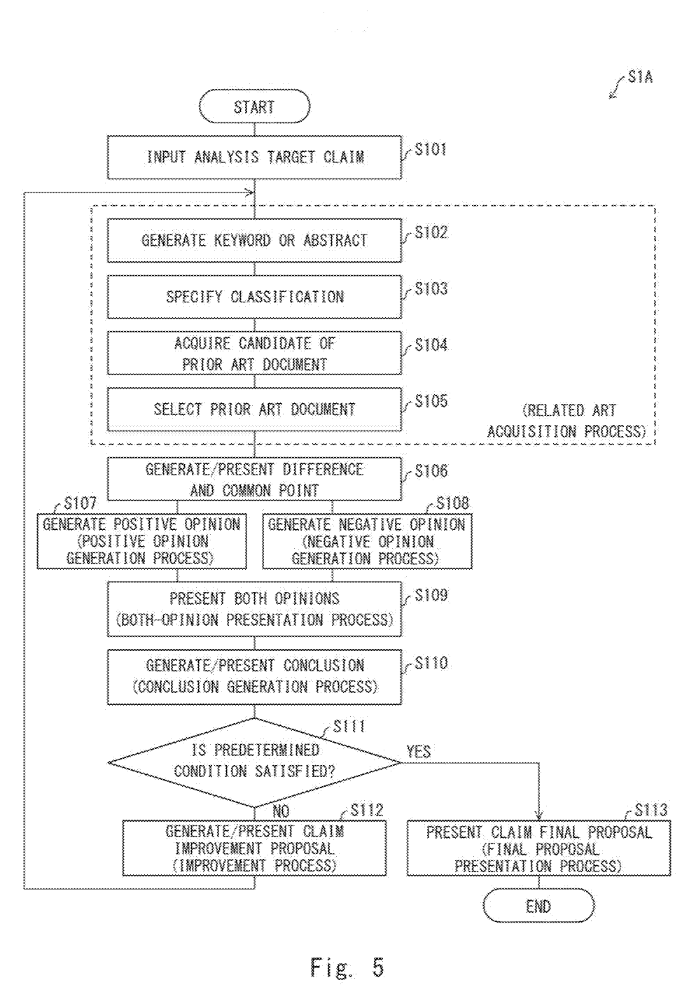

The information processing apparatus 1A configured as described above executes an information processing method S1A. FIG. 5 is a flowchart illustrating the flow of the information processing method S1A. As illustrated in FIG. 5, the information processing method S1A includes steps S101 to S113.

In step S101, the analysis target acquisition unit 18 acquires an analysis target claim.

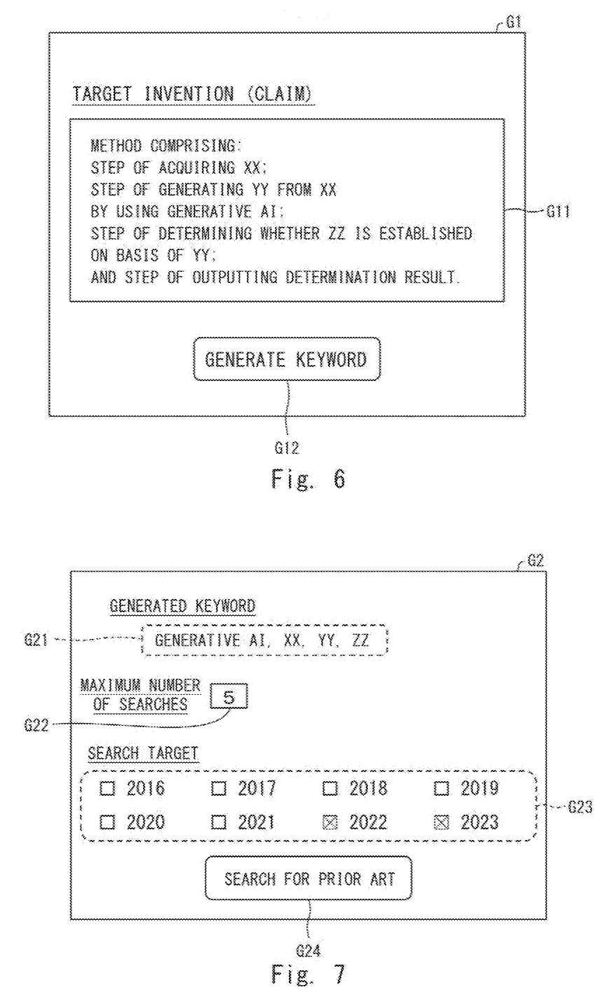

FIG. 6 is a diagram schematically illustrating an example of an analysis target input screen displayed on the display device 5 in step S101. As illustrated in FIG. 6, a screen example G1 includes a claim input region G11 and an operation object G12. The claim input region G11 receives input of a natural language sentence indicating the analysis target claim. The input natural language sentence is displayed in the claim input region G11. In the screen example G1, an example in which one claim is input is illustrated, but a plurality of claims may be input. A plurality of claims may be in a parallel relationship or in a citation relationship. For example, in a case where an operation on an operation object G12 is received, the next step S102 is executed.

Steps S102 to S104 are an example of a related art acquisition process. In step S102, the related art acquisition unit 11 generates a keyword or an abstract from the analysis target claim. For example, in a case of generating a keyword, the keyword generation unit 111 generates a keyword from the analysis target claim by using the large language model LLM1. For example, in a case of generating an abstract, the abstract generation unit 112 generates an abstract from the analysis target claim by using the large language model LLM2. Which one of the keyword and the abstract is generated is as described above, and thus the detailed description will not be repeated. The screen example G1 illustrates an example in which a keyword is generated by using the natural language sentence input to the claim input region G11 as the analysis target claim.

FIG. 7 is a diagram schematically illustrating an example of a generated keyword screen displayed on the display device 5 in step S102. As illustrated in FIG. 7, a screen example G2 includes a keyword region G21, a search number setting region G22, a search target setting region G23, and an operation object G24. The keyword region G21 indicates a keyword generated from the analysis target claim. In this example, four keywords are generated. The search number setting region G22 receives an operation of setting the number to be acquired as candidates for prior art documents. In this example, five are set. That is, five candidates are acquired as candidates for prior art documents. The search target setting region G23 receives an operation of setting a search target from which a candidate for a prior art document is to be searched for. In this example, it is possible to select whether to set each of the disclosure ages as a search target among the patent documents recorded in the database 3, and 2022 and 2023 are set as search targets. For example, in a case where the operation on the operation object G24 is received, the next steps S103 to S105 are executed. In a case where an abstract is generated instead of a keyword, the screen example G2 includes a region where an abstract is displayed instead of the keyword region G21.

In step S103, the classification specifying unit 113 specifies a classification of the invention indicated by the analysis target claim by using the large language model LLM3.

In step S104, the candidate acquisition unit 114 acquires a plurality of patent documents from the database 3 based on the similarity with the keyword or the abstract. The candidate acquisition unit 114 acquires, as a plurality of candidates for prior art documents, documents matching the specified classification among the plurality of patent documents. In a case where there is one candidate acquired in step S104, the candidate is regarded as a prior art document, and the next step S105 is skipped.

In step S105, the related art selection unit 115 selects a prior art document from among the plurality of candidates by using the large language model LLM4. As described above, the related art selection unit 115 may select a prior art document from among a plurality of candidates based on a user’s operation instead of using the large language model LLM4. The prior art documents that have not been selected among the plurality of candidates for prior art documents may be used for further fine-tuning of some or all of the large language models LLM1 to LLM9, in-context learning, or the like.

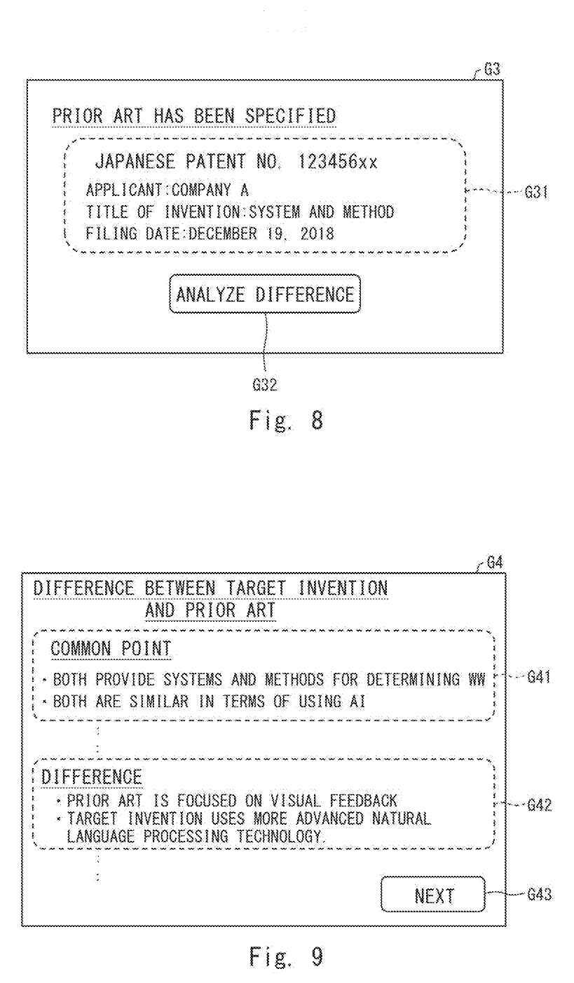

FIG. 8 is a diagram schematically illustrating an example of a prior art screen displayed on the display device 5 in step S105. As illustrated in FIG. 8, a screen example G3 includes a prior art document region G31 and an operation object G32. The prior art document region G31 shows an outline of the prior art document selected by the related art selection unit 115. In the screen example G3, the bibliographic matter is displayed as an outline, but the prior art document region G31 may include other information (for example, an abstract and independent claims). For example, in a case where an operation on the operation object G32 is received, the next step S106 is executed.

In step S106, the difference generation unit 19 generates a difference and a common point between the analysis target claim and the prior art document by using the large language model LLM5. The difference generation unit 19 presents the generated difference and common point to the user, for example, by displaying the generated difference and common point on the display device 5. In a case where a plurality of claims are input as analysis target claims, the difference generation unit 19 may generate a difference and a common point for each claim.

FIG. 9 is a diagram schematically illustrating an example of a difference screen displayed on the display device 5 in step S106. As illustrated in FIG. 9, a screen example G4 includes a common point region G41, a difference region G42, and an operation object G43. The common point region G41 includes common points between the analysis target claim and the prior art document. The difference region G42 includes differences between the analysis target claim and the prior art document. For example, in a case where an operation on the operation object G43 is received, the next steps S107 to S109 are executed.

Step S107 is an example of a positive opinion generation process. In step S107, the positive opinion generation unit 12 generates a positive opinion regarding novelty and inventive step of the target invention indicated by the analysis target claim based on the analysis target claim and the prior art document by using the large language model LLM6. In a case where a plurality of claims are input as analysis target claims, the positive opinion generation unit 12 may generate a positive opinion for each claim.

Step S108 is an example of a negative opinion generation process. In step S108, the negative opinion generation unit 13 generates a negative opinion regarding novelty and inventive step of the target invention indicated by the analysis target claim based on the analysis target claim and the prior art document by using the large language model LLM7. In a case where a plurality of claims are input as analysis target claims, the negative opinion generation unit 13 may generate a negative opinion for each claim.

The execution order of steps S107 and S108 is not limited to the above-described order, and the steps may be executed in the reverse order, or some or all of the steps may be executed in parallel.

Step S109 is an example of a both-opinion presentation process. In step S109, the both-opinion presentation unit 16 presents the positive opinion and the negative opinion to the user, for example, by displaying the opinions on the display device 5.

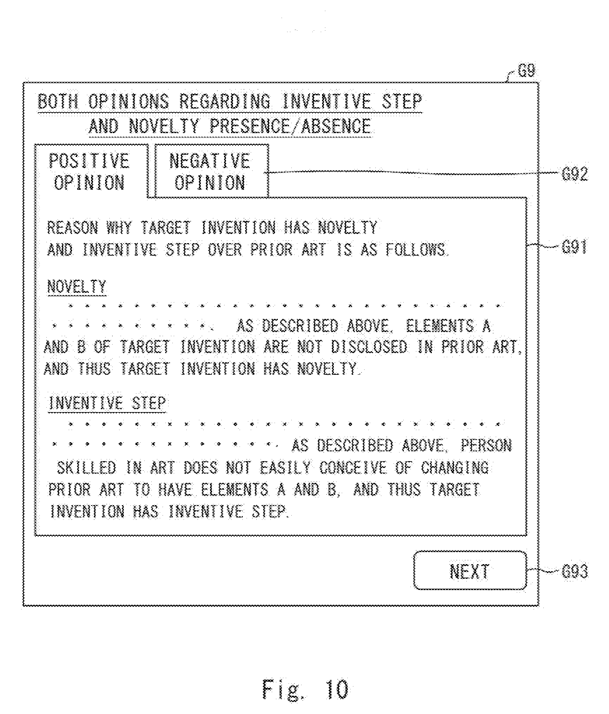

FIG. 10 is a diagram schematically illustrating an example of a both-opinion screen displayed on the display device 5 in step S109. As illustrated in FIG. 10, a screen example G9 includes a positive opinion region G91 and operation objects G92 and G93. The positive opinion region G91 includes a positive opinion regarding novelty and a positive opinion regarding inventive step. The positive opinion includes a sentence indicating an opinion that “the target invention has novelty” and a sentence indicating the grounds therefor “······ ~ (omitted) ~ not disclosed”. The positive opinion includes a sentence indicating an opinion that “the target invention has inventive step” and a sentence indicating the grounds for the opinion “······ ~ (omitted) ~ cannot be easily conceived”. In a case where a plurality of claims are input as analysis target claims, the positive opinion may be classified and displayed for each claim. The operation object G92 receives an operation of giving an instruction for displaying a negative opinion. In a case where an operation on the operation object G92 is received, the screen example G9 transitions to a screen example G10 that will be described below.

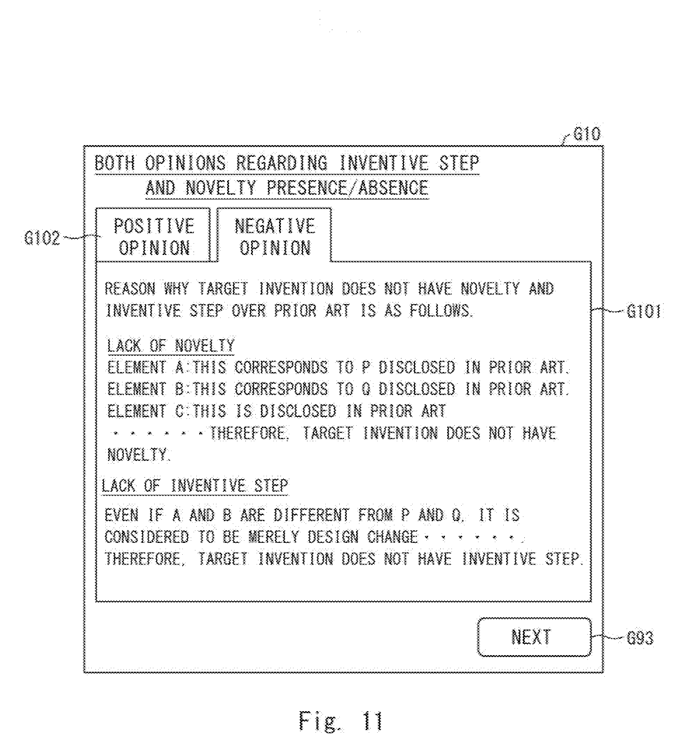

FIG. 11 is a diagram schematically illustrating another example of the both-opinion screen displayed on the display device 5 in step S109. As illustrated in FIG. 11, a screen example G10 includes a negative opinion region G101 and operation objects G102 and G93. The negative opinion region G101 includes a negative opinion regarding novelty and a negative opinion regarding inventive step. The negative opinion includes a sentence indicating an opinion that “the target invention does not have novelty” and a sentence indicating the grounds therefor “element A: ~ (omitted) ~ ···”. The negative opinion includes a sentence indicating an opinion that “the target invention does not have inventive step” and a sentence indicating the grounds therefor “A and B are considered to be ... (omitted)”. In a case where a plurality of claims are input as analysis target claims, the negative opinion may be classified and displayed for each claim. The operation object G102 receives an operation for giving an instruction for displaying a positive opinion. In a case where an operation on the operation object G102 is received, the screen example G10 transitions to the screen example G9 described above.

As described above, since the screen examples G9 and G10 can be switched and displayed, the user can check both positive and negative opinions regarding novelty and inventive step of the target invention. Instead of displaying the positive opinion and the negative opinion in a switching manner as in the screen examples G9 and G10, the both opinions may be included and displayed in one screen.

In a case where an operation on the operation object G93 is received in the screen example G9 or G10, the next step S110 is executed.

Step S110 is an example of a conclusion generation process. In step S110, the conclusion generation unit 14 generates a conclusion regarding novelty and inventive step of the target invention indicated by the analysis target claim based on the analysis target claim, the prior art documents, the positive opinion, and the negative opinion by using the large language model LLM8. The conclusion generation unit 14 presents the generated conclusion to the user, for example, by displaying the generated conclusion on the display device 5.

In step S111, the control unit 110 determines whether the conclusion satisfies a predetermined condition. As described above, the predetermined condition may be that a positive opinion regarding novelty and inventive step is valid, or may be that a positive opinion regarding at least novelty is valid. A case where Yes is determined in step S111 will be described later. In a case where No is determined in step S111, the next step S112 is executed.

Step S112 is an example of an improvement process. In step S112, the improvement unit 15 generates a claim improvement proposal based on the analysis target claim, the prior art documents, the difference and the common point, the negative opinion, the positive opinion, and the conclusion by using the large language model LLM9. The improvement unit 15 presents the generated claim improvement proposal to the user, for example, by displaying the claim improvement proposal on the display device 5.

Next, the control unit 110 repeatedly executes the processes from step S102 with the claim improvement proposal as a new analysis target claim.

In a case where Yes is determined in step S111, step S113 is executed. In step S113, the final proposal presentation unit 17 presents, to the user, the latest claim improvement proposal that is the analysis target claim in which the conclusion satisfies the predetermined condition, as the claim final proposal, for example, by displaying the claim improvement proposal on the display device 5.

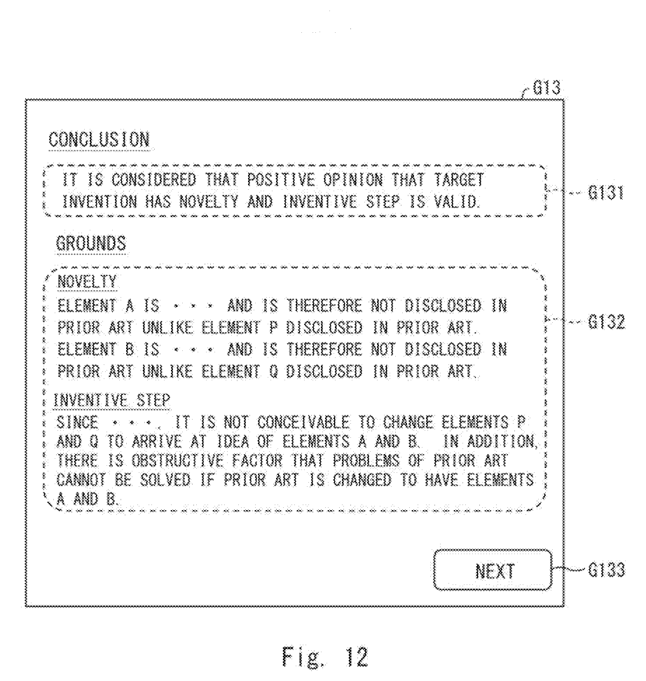

FIG. 12 is a diagram schematically illustrating an example of a conclusion screen indicating a conclusion determined to satisfy the predetermined condition in step S111. The conclusion screen is also an example of a conclusion screen displayed on the display device 5 in step S110. As illustrated in FIG. 12, a screen example G13 includes a conclusion region G131 and a ground region G132. The conclusion region G131 includes, in this example, a conclusion that a positive opinion is valid. The ground region G132 includes a sentence indicating the grounds.

FIG. 13 is a diagram schematically illustrating an example of a final proposal screen displayed on the display device 5 in step S113. As illustrated in FIG. 13, a screen example G14 includes a final proposal region G141. In the final proposal region G141, a changed portion with respect to the original analysis target claim is displayed in a recognizable display aspect (in this example, an underlined display aspect). A display aspect in which the changed portion can be recognized is not limited to an underline, and may be a display aspect with a marker or the like, but is not limited thereto.

### Effects of Information Processing Apparatus 1A and Information Processing Method S1A

As described above, the information processing apparatus 1A further includes the improvement unit 15 that generates the improvement proposal information indicating the improvement proposal of analysis target information by using the fourth large language model, and adopts a configuration in which the related art acquisition unit 11, the positive opinion generation unit 12, the negative opinion generation unit 13, the conclusion generation unit 14, and the improvement unit 15 further function with improvement proposal information as analysis target information. Therefore, according to the information processing apparatus 1A, in addition to the effects obtained by the information processing apparatus 1, it is possible to obtain an effect in which a possibility of acquiring a right to an intellectual property indicated by analysis target information can be increased in stages by repeatedly generating improvement proposal information.

The information processing apparatus 1A has a configuration in which the related art acquisition unit 11 generates a keyword from analysis target information by using the fifth large language model, and acquires related art information from the database by using the generated keyword. Therefore, according to the information processing apparatus 1A, in addition to the effects obtained by the information processing apparatus 1, it is possible to obtain more appropriate related art information.

The information processing apparatus 1A adopts a configuration in which the related art acquisition unit 11 acquires a plurality of candidates for the related art information, and selects one from among the plurality of candidates as related art information by using the sixth large language model. Therefore, according to the information processing apparatus 1A, in addition to the effects obtained by the information processing apparatus 1, it is possible to obtain more appropriate related art information.

The information processing apparatus 1A adopts a configuration in which the related art acquisition unit 11 specifies a classification of an analysis target intellectual property by using the seventh large language model, and acquires related art information by using the specified classification. Therefore, it is possible to acquire more appropriate related art information.

The information processing apparatus 1A adopts a configuration of further including the both-opinion presentation unit 16 that presents a positive opinion and a negative opinion to a user. Therefore, according to the information processing apparatus 1A, in addition to the effects obtained by the information processing apparatus 1, it is possible to obtain an effect in which a user’s satisfaction with a conclusion can be further improved by allowing the user to recognize both the positive opinion and the negative opinion.

The information processing apparatus 1A adopts a configuration of further including the final proposal presentation unit 17 that presents, in a case where a conclusion generated by using improvement proposal information as analysis target information satisfies a predetermined condition, the improvement proposal information to the user as final proposal information. Therefore, according to the information processing apparatus 1A, in addition to the effect obtained by the information processing apparatus 1, it is possible to obtain an effect in which a user can be provided with a claim improvement proposal for enhancing the possibility of acquiring a right.

### Modified Examples

In the second exemplary example embodiment, an analysis target intellectual property is not limited to an invention. For example, another intellectual property described in a natural language sentence such as a device may be applied as an analysis target intellectual property. A possibility of acquiring a right is not limited to being applied to both novelty and inventive step, and may be applied to either one. In addition to novelty and/or inventive step, other requirements may be applied as the possibility of acquiring a right. The analysis target information is not limited to claims. For example, instead of or in addition to claims, information including an outline, detailed description, idea, or the like may be applied as the analysis target information. As the related art information, not only patent documents but also non-patent documents may be applied. The number of prior art documents is not limited to one, and may be plural.

### Example of Implementation by Software

Some or all of the functions of the information processing apparatuses 1 and 1A and the respective devices (hereinafter, also referred to as “each of the above devices”) configuring the information processing system 100A may be implemented by hardware such as an integrated circuit (IC chip) or may be implemented by software.

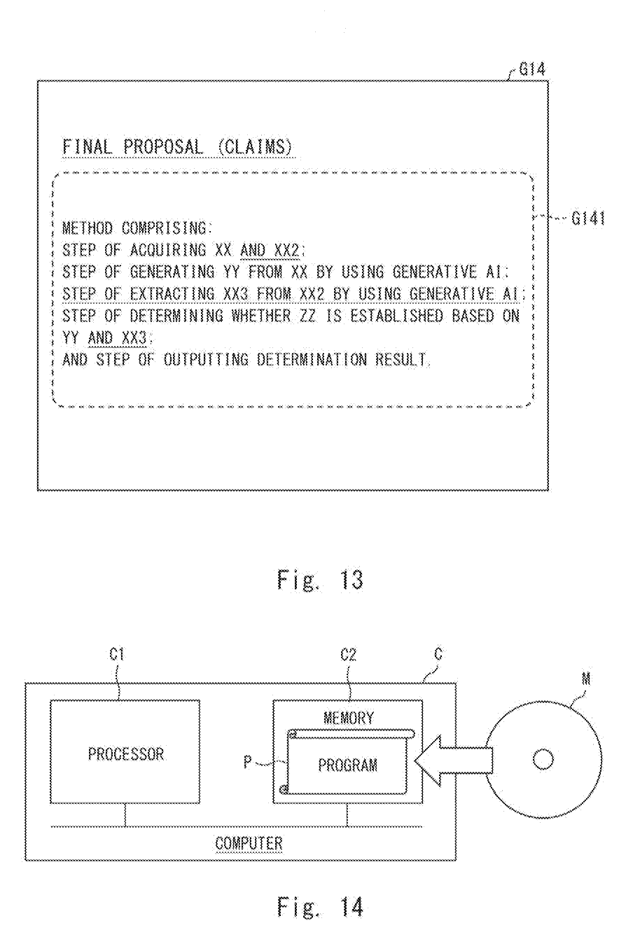

In the latter case, each of the above devices is achieved by, for example, a computer that executes a command of a program as software for achieving each function. An example of such a computer (hereinafter, referred to as a computer C) is illustrated in FIG. 14. FIG. 14 is a block diagram illustrating a hardware configuration of the computer C functioning as each of the above apparatuses.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

As the processor C1, for example, a CPU (Central Processing Unit), a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof may be used. As the memory C2, for example, a flash memory, an HDD (Hard Disk Drive), an SSD (Solid State Drive), or a combination thereof may be used.

The computer C may further include a RAM (Random Access Memory) for loading the program P at the time of execution and temporarily storing various types of data. The computer C may further include a communication interface for sending and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Note A

The whole or part of the example embodiments disclosed above can be described as, but not limited to, the following supplementary notes.

### Supplementary Note A1

An information processing apparatus including: related art acquisition means for acquiring related art information indicating related art related to an analysis target intellectual property based on analysis target information in which the analysis target intellectual property is described in a natural language sentence; positive opinion generation means for generating a positive opinion regarding a possibility of acquiring a right to the analysis target intellectual property based on the analysis target information and the related art information by using a first large language model; negative opinion generation means for generating a negative opinion regarding the possibility of acquiring the right based on the analysis target information and the related art information by using a second large language model; and conclusion generation means for generating a conclusion regarding the possibility of acquiring the right based on the positive opinion and the negative opinion by using a third large language model.

### Supplementary Note A2

The information processing apparatus according to Supplementary Note A1, further including improvement means for generating improvement proposal information indicating an improvement proposal of the analysis target information by using a fourth large language model, in which the related art acquisition means, the positive opinion generation means, the negative opinion generation means, the conclusion generation means, and the improvement means further function with the improvement proposal information as the analysis target information.

### Supplementary Note A3

The information processing apparatus according to Supplementary Note A1 or A2, in which the related art acquisition means generates a keyword or an abstract from the analysis target information by using a fifth large language model, and acquires the related art information from a database by using the generated keyword or abstract.

### Supplementary Note A4

The information processing apparatus according to any one of Supplementary Notes A1 to A3, in which the related art acquisition means acquires a plurality of candidates for the related art information, and selects any one of the plurality of candidates as the related art information by using a sixth large language model.

### Supplementary Note A5

The information processing apparatus according to any one of Supplementary Notes A1 to A4, in which the related art acquisition means specifies a classification of the analysis target intellectual property by using a seventh large language model, and acquires the related art information by using the specified classification.

### Supplementary Note A6

The information processing apparatus according to any one of Supplementary Notes A1 to A5, further including both-opinion presentation means for presenting the positive opinion and the negative opinion to a user.

### Supplementary Note A7

The information processing apparatus according to Supplementary Note A2, further including final proposal presentation means for presenting the improvement proposal information to a user as final proposal information in a case where the conclusion generated by using the improvement proposal information as the analysis target information satisfies a predetermined condition.

### Supplementary Note B

The whole or part of the example embodiments disclosed above can be described as, but not limited to, the following supplementary notes.

### Supplementary Note B1

An information processing method including: a related art acquisition process of, by at least one processor, acquiring related art information indicating related art related to an analysis target intellectual property based on analysis target information in which the analysis target intellectual property is described in a natural language sentence; a positive opinion generation process of, by the at least one processor, generating a positive opinion regarding a possibility of acquiring a right to the analysis target intellectual property based on the analysis target information and the related art information by using a first large language model; a negative opinion generation process of, by the at least one processor, generating a negative opinion regarding the possibility of acquiring the right based on the analysis target information and the related art information by using a second large language model; and a conclusion generation process of, by the at least one processor, generating a conclusion regarding the possibility of acquiring the right based on the positive opinion and the negative opinion by using a third large language model.

### Supplementary Note B2

The information processing method according to Supplementary Note B1, further including an improvement process of, by the at least one processor, generating improvement proposal information indicating an improvement proposal of the analysis target information by using a fourth large language model, in which the at least one processor causes the related art acquisition process, the positive opinion generation process, the negative opinion generation process, the conclusion generation process, and the improvement process to further function with the improvement proposal information as the analysis target information.

### Supplementary Note B3

The information processing method according to Supplementary Note B1 or B2, in which, in the related art acquisition process, the at least one processor generates a keyword or an abstract from the analysis target information by using a fifth large language model, and acquires the related art information from a database by using the generated keyword or abstract.

### Supplementary Note B4

The information processing method according to any one of Supplementary Notes B1 to B3, in which, in the related art acquisition process, the at least one processor acquires a plurality of candidates for the related art information, and selects any one of the plurality of candidates as the related art information by using a sixth large language model.

### Supplementary Note B5

The information processing method according to any one of Supplementary Notes B1 to B4, in which, in the related art acquisition process, the at least one processor specifies a classification of the analysis target intellectual property by using a seventh large language model, and acquires the related art information by using the specified classification.

### Supplementary Note B6

The information processing method according to any one of Supplementary Notes B1 to B5, further including a both-opinion presentation process of, by the at least one processor, presenting the positive opinion and the negative opinion to a user.

### Supplementary Note B7

The information processing method according to Supplementary Note B2, further including a final proposal presentation process of, by the at least one processor, presenting the improvement proposal information to a user as final proposal information in a case where the conclusion generated by using the improvement proposal information as the analysis target information satisfies a predetermined condition.

### Supplementary Note C

The whole or part of the example embodiments disclosed above can be described as, but not limited to, the following supplementary notes.

### Supplementary Note C1

A program for causing a computer to function as an information processing apparatus, the program causing the computer to execute: related art acquisition means for acquiring related art information indicating related art related to an analysis target intellectual property based on analysis target information in which the analysis target intellectual property is described in a natural language sentence; positive opinion generation means for generating a positive opinion regarding a possibility of acquiring a right to the analysis target intellectual property based on the analysis target information and the related art information by using a first large language model; negative opinion generation means for generating a negative opinion regarding the possibility of acquiring the right based on the analysis target information and the related art information by using a second large language model; and conclusion generation means for generating a conclusion regarding the possibility of acquiring the right based on the positive opinion and the negative opinion by using a third large language model.

### Supplementary Note C2

The information processing program according to Supplementary Note C1, in which the computer is caused to further function as improvement means for generating improvement proposal information indicating an improvement proposal of the analysis target information by using a fourth large language model, and the related art acquisition means, the positive opinion generation means, the negative opinion generation means, the conclusion generation means, and the improvement means further function with the improvement proposal information as the analysis target information.

### Supplementary Note C3

The information processing program according to Supplementary Note C1 or C2, in which the related art acquisition means generates a keyword or an abstract from the analysis target information by using a fifth large language model, and acquires the related art information from a database by using the generated keyword or abstract.

### Supplementary Note C4

The information processing program according to any one of Supplementary Notes C1 to C3, in which the related art acquisition means acquires a plurality of candidates for the related art information, and selects any one of the plurality of candidates as the related art information by using a sixth large language model.

### Supplementary Note C5

The information processing program according to any one of Supplementary Notes C1 to C4, in which the related art acquisition means specifies a classification of the analysis target intellectual property by using a seventh large language model, and acquires the related art information by using the specified classification.

### Supplementary Note C6

The information processing program according to any one of Supplementary Notes C1 to C5, in which the computer is caused to further function as both-opinion presentation means for presenting the positive opinion and the negative opinion to a user.

### Supplementary Note C7

The information processing program according to Supplementary Note C2, in which the computer is caused to further function as final proposal presentation means for presenting the improvement proposal information to a user as final proposal information in a case where the conclusion generated by using the improvement proposal information as the analysis target information satisfies a predetermined condition.

### Supplementary Note D

The whole or part of the example embodiments disclosed above can be described as, but not limited to, the following supplementary notes.

### Supplementary Note D1

An information processing apparatus comprising: at least one processor, in which the at least one processor executes a related art acquisition process of acquiring related art information indicating related art related to an analysis target intellectual property based on analysis target information in which the analysis target intellectual property is described in a natural language sentence; a positive opinion generation process of generating a positive opinion regarding a possibility of acquiring a right to the analysis target intellectual property based on the analysis target information and the related art information by using a first large language model; a negative opinion generation process of generating a negative opinion regarding the possibility of acquiring the right based on the analysis target information and the related art information by using a second large language model; and a conclusion generation process of generating a conclusion regarding the possibility of acquiring the right based on the positive opinion and the negative opinion by using a third large language model.

The information processing apparatus may further include a memory. The memory may store a program for causing the at least one processor to execute each of the processes.

### Supplementary Note D2

The information processing apparatus according to Supplementary Note D1, in which the at least one processor further executes an improvement process of generating improvement proposal information indicating an improvement proposal of the analysis target information by using a fourth large language model, and the related art acquisition process, the positive opinion generation process, the negative opinion generation process, the conclusion generation process, and the improvement process are caused to further function with the improvement proposal information as the analysis target information.

### Supplementary Note D3

The information processing apparatus according to Supplementary Note D1 or D2, in which, in the related art acquisition process, the at least one processor generates a keyword or an abstract from the analysis target information by using a fifth large language model, and acquires the related art information from a database by using the generated keyword or abstract.

### Supplementary Note D4

The information processing apparatus according to any one of Supplementary Notes D1 to D3, in which, in the related art acquisition process, the at least one processor acquires a plurality of candidates for the related art information, and selects any one of the plurality of candidates as the related art information by using a sixth large language model.

### Supplementary Note D5

The information processing apparatus according to any one of Supplementary Notes D1 to D4, in which in the related art acquisition process, the at least one processor specifies a classification of the analysis target intellectual property by using a seventh large language model, and acquires the related art information by using the specified classification.

### Supplementary Note D6

The information processing apparatus according to any one of Supplementary Notes D1 to D5, in which the at least one processor further executes a both-opinion presentation process of presenting the positive opinion and the negative opinion to a user.

### Supplementary Note D7

The information processing apparatus according to Supplementary Note D2, in which the at least one processor further executes a final proposal presentation process of presenting the improvement proposal information to a user as final proposal information in a case where the conclusion generated by using the improvement proposal information as the analysis target information satisfies a predetermined condition.

### Supplementary Note E

The whole or part of the example embodiments disclosed above can be described as, but not limited to, the following supplementary notes.

### Supplementary Note E1

A non-transitory recording medium storing an information processing program for causing a computer to function as an information processing apparatus and the computer to execute: related art acquisition process of acquiring related art information indicating related art related to an analysis target intellectual property based on analysis target information in which the analysis target intellectual property is described in a natural language sentence; positive opinion generation process of generating a positive opinion regarding a possibility of acquiring a right to the analysis target intellectual property based on the analysis target information and the related art information by using a first large language model; negative opinion generation process of generating a negative opinion regarding the possibility of acquiring the right based on the analysis target information and the related art information by using a second large language model; and conclusion generation process of generating a conclusion regarding the possibility of acquiring the right based on the positive opinion and the negative opinion by using a third large language model.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to perform:
a related art acquisition process of acquiring related art information indicating related art related to an analysis target intellectual property based on analysis target information in which the analysis target intellectual property is described in a natural language sentence;
a positive opinion generation process of generating a positive opinion regarding a possibility of acquiring a right to the analysis target intellectual property based on the analysis target information and the related art information by using a first large language model;
a negative opinion generation process of generating a negative opinion regarding the possibility of acquiring the right based on the analysis target information and the related art information by using a second large language model; and
a conclusion generation process of generating a conclusion regarding the possibility of acquiring the right based on the positive opinion and the negative opinion by using a third large language model.

2. The information processing apparatus according to claim 1, wherein
the at least one processor further executes an instruction to perform an improvement process of generating improvement proposal information indicating an improvement proposal of the analysis target information by using a fourth large language model, and
the related art acquisition process, the positive opinion generation process, the negative opinion generation process, the conclusion generation process, and the improvement process are further performed with the improvement proposal information as the analysis target information.

3. The information processing apparatus according to claim 1, wherein the related art acquisition process includes a process of generating a keyword or an abstract from the analysis target information by using a fifth large language model, and acquiring the related art information from a database by using the generated keyword or abstract.

4. The information processing apparatus according to claim 1, wherein the related art acquisition process includes a process of acquiring a plurality of candidates for the related art information and selecting one of the plurality of candidates as the related art information by using a sixth large language model.

5. The information processing apparatus according to claim 1, wherein the related art acquisition process includes a process of specifying a classification of the analysis target intellectual property by using a seventh large language model, and acquiring the related art information by using the specified classification.

6. The information processing apparatus according to claim 1, wherein the at least one processor further executes an instruction to perform a both-opinion presentation process of presenting the positive opinion and the negative opinion to a user.

7. The information processing apparatus according to claim 2, wherein the at least one processor further executes an instruction to perform a final proposal presentation process of presenting the improvement proposal information to a user as final proposal information in a case where the conclusion generated by using the improvement proposal information as the analysis target information satisfies a predetermined condition.

8. An information processing method comprising:
a related art acquisition process of, by at least one processor, acquiring related art information indicating related art related to an analysis target intellectual property based on analysis target information in which the analysis target intellectual property is described in a natural language sentence;
a positive opinion generation process of, by the at least one processor, generating a positive opinion regarding a possibility of acquiring a right to the analysis target intellectual property based on the analysis target information and the related art information by using a first large language model;
a negative opinion generation process of, by the at least one processor, generating a negative opinion regarding the possibility of acquiring the right based on the analysis target information and the related art information by using a second large language model; and
a conclusion generation process of, by the at least one processor, generating a conclusion regarding the possibility of acquiring the right based on the positive opinion and the negative opinion by using a third large language model.

9. The information processing method according to claim 8, further comprising an improvement process of, by the at least one processor, generating improvement proposal information indicating an improvement proposal of the analysis target information by using a fourth large language model,
wherein the related art acquisition process, the positive opinion generation process, the negative opinion generation process, the conclusion generation process, and the improvement process are further performed with the improvement proposal information as the analysis target information.

10. The information processing method according to claim 8, wherein, in the related art acquisition process, the at least one processor generates a keyword or an abstract from the analysis target information by using a fifth large language model, and acquires the related art information from a database by using the generated keyword or abstract.

11. The information processing method according to claim 8, wherein, in the related art acquisition process, the at least one processor acquires a plurality of candidates for the related art information, and selects any one of the plurality of candidates as the related art information by using a sixth large language model.

12. The information processing method according to claim 8, wherein, in the related art acquisition process, the at least one processor specifies a classification of the analysis target intellectual property by using a seventh large language model, and acquires the related art information by using the specified classification.

13. The information processing method according to claim 8, further comprising a both-opinion presentation process of, by the at least one processor, presenting the positive opinion and the negative opinion to a user.

14. The information processing method according to claim 9, further comprising a final proposal presentation process of, by the at least one processor, presenting the improvement proposal information to a user as final proposal information in a case where the conclusion generated by using the improvement proposal information as the analysis target information satisfies a predetermined condition.

15. A non-transitory computer readable medium storing an information processing program for causing a computer to execute:
a related art acquisition process of acquiring related art information indicating related art related to an analysis target intellectual property based on analysis target information in which the analysis target intellectual property is described in a natural language sentence;
a positive opinion generation process of generating a positive opinion regarding a possibility of acquiring a right to the analysis target intellectual property based on the analysis target information and the related art information by using a first large language model;
a negative opinion generation process of generating a negative opinion regarding the possibility of acquiring the right based on the analysis target information and the related art information by using a second large language model; and
a conclusion generation process of generating a conclusion regarding the possibility of acquiring the right based on the positive opinion and the negative opinion by using a third large language model.

16. The non-transitory computer readable medium storing the information processing program according to claim 15, wherein the computer is caused to further execute an improvement process of generating improvement proposal information indicating an improvement proposal of the analysis target information by using a fourth large language model, and the computer is caused to further execute the related art acquisition process, the positive opinion generation process, the negative opinion generation process, the conclusion generation process, and the improvement process with the improvement proposal information as the analysis target information.

17. The non-transitory computer readable medium storing the information processing program according to claim 15, wherein the related art acquisition process includes a process of generating a keyword or an abstract from the analysis target information by using a fifth large language model, and acquiring the related art information from a database by using the generated keyword or abstract.

18. The non-transitory computer readable medium storing the information processing program according to claim 15, wherein the related art acquisition process includes a process of acquiring a plurality of candidates for the related art information and selecting one of the plurality of candidates as the related art information by using a sixth large language model.

19. The non-transitory computer readable medium storing the information processing program according to claim 15, wherein the related art acquisition process includes a process of specifying a classification of the analysis target intellectual property by using a seventh large language model, and acquiring the related art information by using the specified classification.

20. The non-transitory computer readable medium storing the information processing program according to claim 15, wherein the computer is caused to further execute an instruction to perform a both-opinion presentation process of presenting the positive opinion and the negative opinion to a user.
